(19) United States
(12) Patent Application Publication
(10) Pub. No.: US 2016/0272129 A1
(43) Pub. Date: Sep. 22, 2016

(54) COMMUNICATION DEVICE AND MOTOR VEHICLE COMPRISING SUCH A DEVICE

(71) Applicant: RENAULT S.A.S., Boulogne Billancourt (FR)

(72) Inventors: Vincent BIDAULT, Suresnes (FR); Sergio CAMPOY-MARTINEZ, Issy Les Moulineaux (FR); Josetxo VILLANUEVA, Paris (FR)

(73) Assignee: RENAULT s.a.s., Boulogne Billancourt (FR)

(21) Appl. No.: 14/908,962

(22) PCT Filed: Jun. 30, 2014
(86) PCT No.: PCT/FR2014/051662

§ 371 Date: Jun. 6, 2016

(30) Foreign Application Priority Data
Jul. 31, 2013 (FR) 1357583

(51) Int. Cl. B60R 16/023; H04L 12/40; H04L 25/08

(52) U.S. Cl. CPC B60R 16/023; H04L 25/085; H04L 12/40; H04L 2012/40234; H04L 2012/40273

(57) ABSTRACT

The invention relates to a communication device comprising two electronic control units that each comprise a first electric terminal, a second electric terminal, and a communication terminal connected to the communication terminal of the other electronic control unit by a communication wire, and in which the first electronic control unit has reference voltages (VSUPP, VGND) on its first and second electric terminals and comprises development means suitable for emitting a voltage signal (SLIN) referenced to said reference voltages on its communication terminal, and the second electronic control unit comprises means for processing said voltage signal received on its communication terminal via said communication wire. According to the invention, the communication device comprises two reference wires connecting said first electric terminals to each other, and which also forces said reference wires to travel, with said communication wire, between said two electronic control units.

### TECHNICAL FIELD TO WHICH THE INVENTION RELATES

The present invention is generally concerned with the field of communication between electronic control units.

It is more particularly concerned with a communication device including two electronic control units that each include a first electric terminal, a second electric terminal, and a communication terminal connected to the communication terminal of the other electronic control unit by a communication wire, in which a first of said two electronic control units has reference voltages on its first and second electric terminals and includes generation means suitable for emitting a voltage signal referenced to the reference voltages on its communication terminal, and a second of the two electronic control units includes means for processing the voltage signal received on its communication terminal via the communication wire.

The invention also concerns a motor vehicle including such a communication device.

### TECHNOLOGICAL BACKGROUND

A motor vehicle includes numerous sensors (a rain detector, a brightness sensor, a pressure sensor, etc.) and numerous actuators (a windshield wiper motor, fuel injectors, etc.).

These sensors and these actuators are generally controlled by electronic control units, i.e. processors, that communicate with one another.

For example, a rain detector will include a first electronic control unit that will be connected to a second electronic control unit for controlling a windshield wiper motor.

A communication device as defined in the introduction then enables the electronic control units to communicate with one another.

There is known in particular a communication device in which the electronic control units exchange information via a single communication wire using a voltage signal generated in accordance with an LIN (Local Interconnect Network) type communication protocol, which signal is referenced to first and second reference voltages.

It has been found during electromagnetic compatibility (EMC) tests that such a communication device using a single communication wire could be sensitive to electromagnetic interference emitted in the environment of the motor vehicle, for example interference linked to the operation of various units of the motor vehicle (the engine, the alternator, the actuators) or radio waves received or transmitted in the vicinity of the motor vehicle (FM broadcasts, GSM or WiFi signals, etc.).

In some frequency bands this electromagnetic interference leads to distortion of the voltage signal.

In an environment subject to interference there is therefore a risk of a temporary break in communication and loss of information.

### OBJECT OF THE INVENTION

In order to remedy the aforementioned drawback of the prior art, the present invention proposes a communication device that has increased resistance to electromagnetic interference.

There is more particularly proposed in accordance with the invention a communication device, as defined in the introduction, further including:
two reference wires one of which connects said first electric terminals and the other of which connects said second electric terminals, and
guide means that route said reference wires with said communication wire between said two electronic control units.

In an environment subject to electromagnetic interference the reference voltages and the signal voltage suffer interference when the voltage signal is transmitted.

Thanks to the connection of the first electric terminals and the second electric terminals by the two reference wires and thanks to the guide means it is made certain that these signals suffer interference in the same manner.

In actual fact, a voltage signal is generally generated in such a manner that it varies in steps between a first reference level (equal to a signal voltage fixed by the reference voltage common to the first electric terminals) and a second reference level (equal to a signal voltage fixed by the reference voltage common to the second electrical terminals).

Thanks to the close routing of the reference wires and the communication wire, it is then possible to reduce common mode effects when this voltage signal is transmitted on the communication wire connecting the two electronic control units.

The proposed invention involves minor modifications to existing communication devices. It procures a considerable improvement in electromagnetic immunity simply by placing the communication wire as close as possible to the two reference wires.

Other nonlimiting and advantageous features of the communication device in accordance with the invention are as follows:
said guide means route said reference wires and said communication wire in a substantially parallel manner;
said guide means include a cable sheath housing said reference wires and said communication wire;
said generation means are adapted to generate said voltage signal in accordance with an LIN type communication protocol;
said communication device further includes:
   another electronic control unit that includes a first electric terminal and a second electric terminal, means for processing said voltage signal, and a communication terminal connected to said communication wire by another communication wire to receive said voltage signal,
   two other reference wires respectively connecting said first and second electric terminals of said other electronic control unit to said two reference wires, and
   other guide means that route said two other reference wires with said other communication wire;
the connections of said two other reference wires with said two reference wires and the connection of said other communication wire with said communication wire are produced by three splices;
the connections of said two other reference wires with said two reference wires and the connection of said other communication wire with said communication wire are produced by a three-pin male connector and a three-pin female connector;
said communication device includes between two and fourteen other electronic control units.

The invention also proposes a motor vehicle that includes a communication device in accordance with the invention.

### DETAILED DESCRIPTION OF ONE EMBODIMENT

The following description with reference to the appended drawings, provided by way of nonlimiting example, will explain clearly in what the invention consists and how it may be implemented.

In the appended drawings:

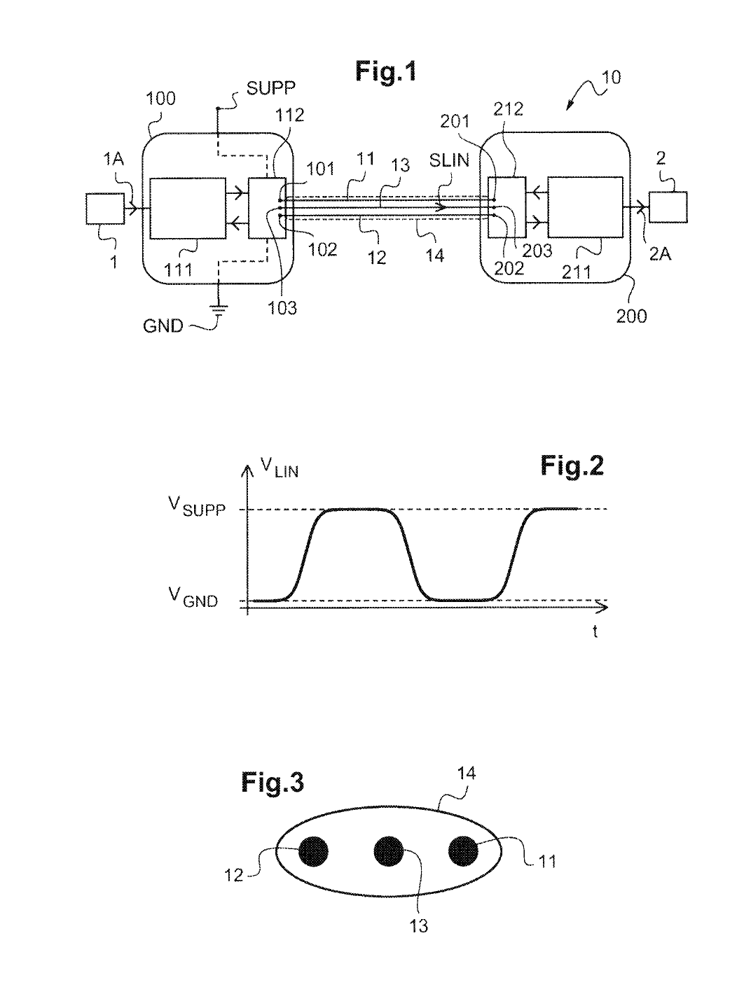

FIG. 1 is a diagrammatic view of a communication device in accordance with a first embodiment of the invention;

FIG. 2 is an example of a voltage signal generated in accordance with an LIN type communication protocol and transmitted by the communication device from FIG. 1;

FIG. 3 is a sectional view of an electric sheath housing the communication wire, the battery wire and the ground wire of the communication device from FIG. 1;

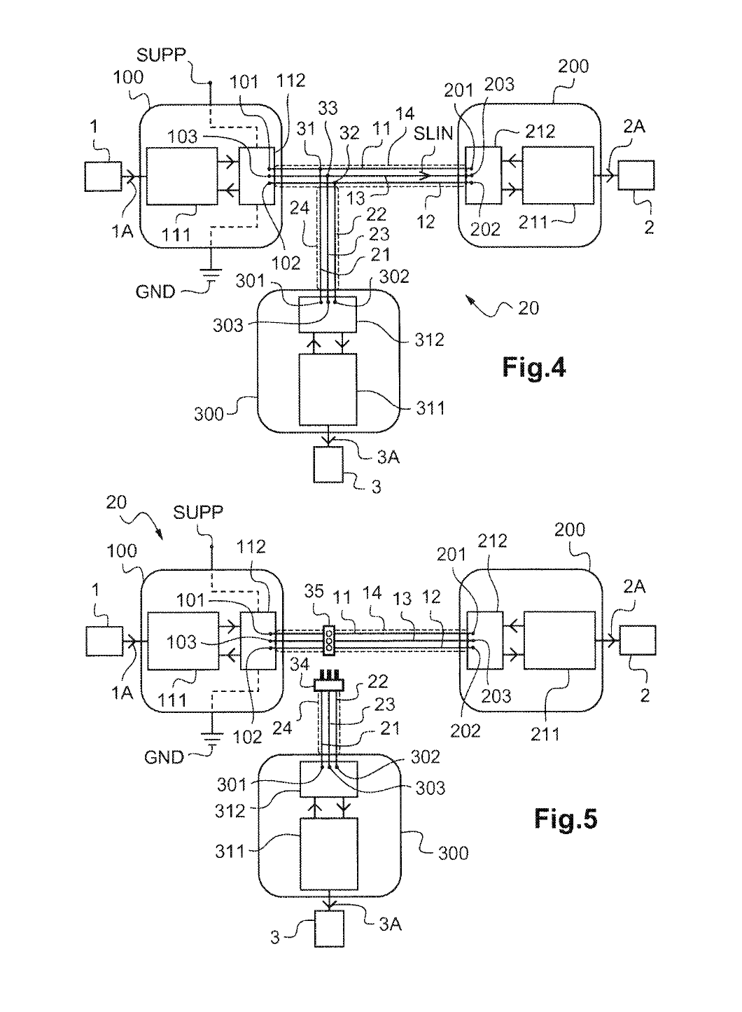

FIG. 4 is a diagrammatic view of a communication device in accordance with a second embodiment of the invention;

FIG. 5 is a diagrammatic view of the communication device in accordance with a variant of the second embodiment of the invention.

By way of introduction, it will be noted that identical or similar elements of the various embodiments represented in the various figures will be referenced by the same reference signs and will not be described each time.

Two particular embodiments of a communication device 10; 20 intended to equip a motor vehicle (not shown), for example, are represented in FIGS. 1 and 4.

Here the communication device 10; 20 is designed to communicate in accordance with an LIN type communication protocol, referred to hereinafter as the “LIN protocol”. The LIN protocol is currently undergoing standardization as part of ISO/CD standard 17987.

Thanks to its simple interface and its implementation using readily available components of relatively low cost, the LIN protocol has an economic advantage in the automotive field compared to other multiplexed communication protocols, for example the CAN (Controller Area Network) type communication protocol defined by the ISO international standard 11898.

The LIN protocol is used in motor vehicles for communication requirements with a low data rate, typically less than around 20 kilobits per second.

As represented in FIGS. 1 and 4, the communication device 10; 20 includes first and second electronic control units 100, 200 hereinafter denoted by their abbreviation UCE.

In the various embodiments of the invention described here, the first UCE 100 controls a rain detector 1 of the motor vehicle and the second UCE 200 controls a windshield wiper motor 2.

In the second embodiment represented in FIG. 4, and in its variant represented in FIG. 5, the communication device 20 further includes a third electronic control unit 300 that controls another windshield wiper motor 3.

In the various examples described in detail hereinafter, and in order to understand clearly the operation of the communication device 10; 20 and the resulting advantages, it will be considered that here the first UCE 100 is in “sender” mode and that the second and third UCE 200, 300 are, for their part, in “receiver” mode.

This means that the first UCE 100 receives a detection signal 1A from the rain detector 1, then processes this detection signal 1A, and finally communicates the result of this processing to the second and third UCE 200, 300 that then control their respective windshield wiper motor 2, 3 via a control signal 2A, 3A.

In the first embodiment of the invention represented in FIG. 1, which includes only two electronic control units 100, 200, the communication device 10 is mainly described and represented to illustrate how the invention works in a simple manner.

In order to be supplied with electric power, the first UCE 100 includes (see FIG. 1) a power supply terminal SUPP and a ground terminal GND.

On the one hand, the power supply terminal SUPP is connected to an electrical distribution unit (not shown) situated in the passenger compartment of the motor vehicle and delivering a supply voltage V_{SUPP} that is a function of the battery voltage V_{BATT}. Here that supply voltage V_{SUPP} is equal to 12 volts.

On the other hand, the ground terminal GND is connected to a ground bolt (not shown) of the motor vehicle situated as close as possible to the first UCE 100. Connected in this way, the ground terminal GND is subjected to a null ground voltage V_{GND} equal to 0 volt.

Each of the first and second UCE 100, 200 includes a first electric terminal 101, 201, a second electric terminal 102, 202, and a communication terminal 103, 203.

Here the first electric terminal 101 of the first UCE 100 is connected directly to the power supply terminal SUPP and the second electric terminal 102 of the first UCE 100 is connected directly to the ground terminal GND and these electric terminals 101, 102 are therefore at a potential difference equal to 12 volts.

The first UCE 100 moreover includes means 111 for generating a voltage signal SLIN referenced to said reference voltages V_{SUPP}, V_{GND}. These generation means 111 are therefore designed to send this voltage signal SLIN to its transmission terminal 103.

Correspondingly, the second UCE 200 includes means 211 for processing the voltage signal SLIN received on its communication terminal 203 via a communication wire 13.

An example of a voltage signal SLIN generated in accordance with an LIN type communication protocol is shown in FIG. 2.

To be more precise, there is shown in FIG. 2 an example of the variation of the voltage V_{LIN} of the voltage signal SLIN as a function of the time t.

In accordance with the LIN protocol, this voltage signal SLIN oscillates between two different voltage levels:
a low level, also referred to as the “dominant” level, that corresponds to a first state of the voltage signal SLIN in which the signal voltage V_{LIN} is equal to the ground voltage V_{GND}, and
a high level, also referred to as the “recessive” level, that corresponds to a second state of the voltage signal SLIN in which the signal voltage V_{LIN} is equal to the supply voltage V_{SUPP}.

The voltage signal SLIN is then said to be referenced to the ground voltage V_{GND} and to the supply voltage V_{SUPP}.

In accordance with one particularly advantageous feature of the invention, the first electric terminals 101, 201 of the two UCE 100, 200 are connected to each other by a first reference wire 11, the two electric terminals 102, 202 of the two UCE 100, 200 are connected to each other by a second reference wire 12, and these two reference wires 11, 12 are routed between the two UCE 100, 200 with the communication wire 13 by the guide means 14.

Variations in the signal voltage V_{LIN} and scrambling of the voltage signal SLIN occur if electromagnetic waves interfere with the transmission of the voltage signal SLIN along the communication wire 13 between the first UCE 100 and the second UCE 200.

The reference voltages V_{SUPP}, V_{GND} carried by the two reference wires 11, 12 will then be affected in the same manner if they are subjected to the same electromagnetic waves, which is the case here because the two reference wires 11, 12 are situated near the communication wire 13.

Because the generation means 111 generate the voltage signal SLIN with reference to the reference voltages V_{SUPP}, V_{GND}, the processing means 211 can then process the voltage signal SLIN received (and subject to interference) with reference to the reference voltages V_{SUPP}, V_{GND} received (and also subject to interference). This results in effective processing of the voltage signal SLIN, even if the latter has suffered strong interference.

Thanks to the guide means 14, the reference wires 11, 12 are routed together with the communication wire 13 between the two UCE 100, 200.

By this is meant that the references wires 11, 12 and the communication wire 13 remain close to one another along the path that connects them from the first UCE 100 to the second UCE 200.

Although in FIG. 1 the wire path that connects the first UCE 100 to the second UCE 200 is a rectilinear path, it is possible, as a function of the constraints in respect of connecting the two UCE 100, 200 in the motor vehicle, for that path to be curved or to feature a number of bends.

Here the guide means include a cable sheath 14 jointly housing (see FIG. 3) the first reference wire 11, the second reference wire 12 and the communication wire 13.

This cable sheath 14 does not necessitate any particular shielding intended to improve its electromagnetic compatibility.

Alternatively, the cable sheath may include electromagnetic shielding in the form of a braid or a drain wire electrically connected to the ground terminal of one or more electronic control units.

The cable sheath 14 preferably routes the two reference wires 11, 12 and the communication wire 13 in a substantially parallel manner.

By this is meant that the two reference wires 11, 12 each remain at a substantially constant separation distance relative to the communication wire 13 and that their tangents are parallel in any cross section of the cable sheath 14.

This ensures that the reference wires 11, 12 suffer the same electromagnetic interference.

To be more precise, here the generation and processing means of the first and second UCE 100, 200 include a digital microcontroller 111, 211 (see FIG. 1) that includes, inter alia, a processor, a random-access memory, a read-only memory and various input or output interfaces for receiving signals from the rain detector (microcontroller 111) or to transmit signals to the windshield wiper motor 2 (microcontroller 211).

The generation and processing means of the first and second UCE 100, 200 moreover include digital/analog converters 112 (first UCE 100) or analog/digital converters 212 (second UCE 200) for converting the digital signals processed by the microcontrollers 111, 211 into an analog voltage signal SLIN or vice versa.

In the FIG. 1 configuration, the detection signal 1A delivered by the rain detector 1 and indicating the presence of water droplets on the windshield of the motor vehicle, for example, is transmitted to the microcontroller 111 of the first UCE 100, which processes this detection signal 1A. As a function of the result of that processing, the microcontroller 111 generates an LIN digital signal in accordance with the LIN protocol, after which the digital/analog converters 112 transmit this voltage signal SLIN in analog form via the communication wire 13 to the second UCE 200. The analog voltage signal SLIN is then converted into an LIN digital signal and then processed by the microcontroller 211 that generates the corresponding control signal 2A to control the windshield wiper motor 2.

In an alternative embodiment, the second UCE of the communication device may also include a power supply terminal at a different supply voltage and a ground terminal at a different ground voltage.

In this embodiment again, the electronic components of the second UCE will then be supplied with power not via the first UCE but directly by the power supply terminal.

In this embodiment again, the second UCE could function as a “sender” because these two supply voltages and this ground voltage could then serve as reference voltages for the first and second electric terminals of the second UCE.

Still in this embodiment, each UCE will include disconnection means adapted to disconnect the first electric terminal from the supply voltage V_{SUPP} and the second electric terminal from the ground voltage V_{GND}.

When sending a voltage signal SLIN from the second UCE to the first UCE, the disconnection means of the second UCE will therefore be commanded to connect the first and second electric terminals to the supply voltage V_{SUPP} and the ground voltage V_{GND}. The disconnection means of the first UCE will for their part be commanded to disconnect the first electric terminal from the supply voltage V_{SUPP} and the second electric terminal from the ground voltage V_{GND}.

In the second embodiment represented in FIG. 4 and in one of its variants represented in FIG. 5, the third UCE 300 of the communication device 20 includes, like the first and second UCE 100, 200:
a first electric terminal 301 connected to the first reference wire 11,
a second electric terminal 302 connected to the second reference wire 12,
processing means 311 (in the form of a microcontroller 311) for processing the voltage signal SLIN in accordance with the LIN protocol, referenced to the first and second reference voltages V_{SUPP}, V_{GND}, and
a communication terminal 303 connected to the communication wire 13 connecting the first and second UCE 100, 200 via another communication wire 23 to receive the voltage signal SLIN.

In order to improve the electromagnetic immunity of the communication device 20, the first electric terminal 301 is connected to the first reference wire 11 and the second electric terminal 302 is connected to the second reference wire 12 via two other reference wires 21, 22 routed with the other communication wire 23.

To this end there are provided other guide means, here consisting of another cable sheath 24 that routes these other wires 21, 22 together with the other communication wire 23.

In the second embodiment shown in FIG. 4 the connections of the two other reference wires 21, 22 with the two reference wires 11, 12 and the connection of the other communication wire 23 with the communication wire 13 are produced by three splices 31, 32, 33.

The third splice 33 between the two communication wires 13, 23 notably enables transmission of the voltage signal SLIN between the third UCE 300 and the other two UCE 100, 200.

In the variant of this second embodiment shown in FIG. 5 the connections of the two other reference wires 21, 22 with the two reference wires 11, 12 and the connection of the other communication wire 23 with the communication wire 13 are produced by a three-pin male connector 34 and a three-pin female connector 35.

Here the three pins of the female connector 35 are connected to the two reference wires 11, 12 and to the communication wire 13 connecting the first UCE 100 to the second UCE 200.

In the same way, the three pins of the male connector 34 are connected to the two other reference wires 21, 22 and to the other communication wire 23 connected to the electric terminals 301, 302 and to the communication terminal 303 of the third UCE 300.

The male connector 34 and the female connector 35 preferably include a polarizer (not shown) for preventing electrical connection errors, for example connection of the other first reference wire 21 to the second reference wire 12.

The communication device may include up to sixteen electronic control units in other embodiments of the invention in which the generation and processing means are adapted to generate a voltage signal in accordance with an LIN type communication protocol.

The present invention is in no way limited to the embodiments described and shown, of which the person skilled in the art may produce any variant conforming to the spirit of the invention.

In particular, the voltage signal could be generated in accordance with a communication protocol other than the LIN protocol using a non-differential voltage signal. Thus there could be a frequency modulated signal the mean value of which and the amplitude of which would serve as reference values.

The electric terminals of the electronic control units could also be connected to the power supply and ground terminals indirectly, for example via a voltage-reducer circuit.

1. A communication device including two electronic control units that each include a first electric terminal, a second electric terminal, and a communication terminal connected to the communication terminal of the other electronic control unit by a communication wire, in which:
a first electronic control unit of said two electronic control units has reference voltages (V_{SUPP}, V_{GND}) on its first and second electric terminals and includes generation means suitable for emitting a voltage signal (SLIN) referenced to said reference voltages (V_{SUPP}, V_{GND}) on its communication terminal, and
a second electronic control unit of said two electronic control units includes means for processing said voltage signal (SLIN) received on its communication terminal via said communication wire,
characterized in that it includes:
two reference wires connecting said first electric terminals to each other and said second electric terminals to each other, and
guide means that route said reference wires with said communication wire between said two electronic control units.

2. The communication device as claimed in claim 1, wherein said guide means route said reference wires and said communication wire in a substantially parallel manner.

3. The communication device as claimed in claim 1, wherein said guide means include a cable sheath housing said reference wires and said communication wire.

4. The communication device as claimed in claim 1, wherein said generation means are adapted to generate said voltage signal (SLIN) in accordance with an LIN type communication protocol.

5. The communication device as claimed in claim 1, further including:
another electronic control unit that includes a first electric terminal and a second electric terminal, means for processing said voltage signal (SLIN), and a communication terminal connected to said communication wire by another communication wire to receive said voltage signal (SLIN),
two other reference wires respectively connecting said first and second electric terminals of said other electronic control unit to said two reference wires, and
other guide means that route said two other reference wires with said other communication wire.

6. The communication device as claimed in claim 1, wherein the connections of said two other reference wires with said two reference wires and the connection of said other communication wire with said communication wire are produced by three splices.

7. The communication device as claimed in claim 5, wherein the connections of said two other reference wires with said two reference wires and the connection of said other communication wire with said communication wire are produced by a three-pin male connector and a three-pin female connector.

8. The communication device as claimed in claim 5, including between two and fourteen other electronic control units.

9. The communication device as claimed in claim 6, including between two and fourteen other electronic control units.

10. The communication device as claimed in claim 7, including between two and fourteen other electronic control units.

11. A motor vehicle characterized in that it includes a communication device as claimed in any one of claims 1 to 10.
